(19) United States
(12) Patent Application Publication
(10) Pub. No.: US 2007/0181586 A1
(43) Pub. Date: Aug. 9, 2007

(54) Storage tank for cold liquids, and method for applying a thermal insulation system in such tank

(76) Inventors: Harry Robert Van Ootmarsum, Goirle (NL); Marco Monzeglio, Gallarate (IT)

Correspondence Address: TROUTMAN SANDERS LLP, 600 PEACHTREE STREET , NE, ATLANTA, GA, 30308, US

(21) Appl. No.: 11/573,265

(22) PCT Filed: Aug. 4, 2004
(86) PCT No.: PCT/NL04/00554

§ 371 Date: Feb. 22, 2007

(51) Int. Cl. F17C 13/00; B65D 81/38

(52) U.S. Cl. 220/592.26; 220/560.12

(57) ABSTRACT

A double containment storage tank, suitable for storing cold liquids, is provided with a non-metallic thermal protection system. The storage tank can include a first vapour-tight and gas-tight PU coating applied by spraying on the inner surface of the floor and walls of the tank; a first insulation PU foam layer arranged on the inner side of the first coating; a second liquid-tight PU coating applied in at least the bottom corner sections of the tank by spraying on the inner surface of the first foam layer; a second insulation PU foam layer arranged on the inner side of the second coating; and a third liquid-tight PU coating arranged by spraying on the inner side of the second foam layer.

### FIELD OF THE INVENTION

The present invention relates in general to the field of storing cold liquids in a large storage tank. Typical operation conditions of such storage tanks are in the range of 0° C. to −200° C. More particularly, the present invention relates to tanks intended for storing substances which are liquid in the temperature range between −5° C. and −196° C., wherein storage takes place under atmospheric pressure. For storage tanks of this type, a Euro-norm applies, indicated as “atmospheric, refrigerated, liquefied gas storage tanks with operating temperatures between −5° C. and −196° C.”. Such tanks are fixedly positioned at a storage location, either above bottom surface or sunken completely in the bottom. Horizontal dimensions of such tanks are typically within the range of 10meters to 100 meters, and the height can typically be up to 50 meter.

Still more particularly, the present invention relates to tanks intended for storing liquid LNG, having a temperature in the range of −102° C. to −165° C.

### BACKGROUND OF THE INVENTION

Tanks for storing such cold liquids, indicated hereinafter as “cold storage tanks”, have to meet a number of design requirements. The constructive strength should be large enough to carry the weight of the liquid, and to withstand the forces that occur in the case of an earthquake. The tank should be liquid-tight, vapor-tight, and should fulfill an isolating function between the surroundings and the cold liquid in the interior. Finally, provisions must be made to prevent that the tank immediately empties completely towards the surroundings in the unlikely event of a leakage of the tank.

Known cold storage tanks are built according to one of the following concepts.

A first tank concept, indicated as “tank-in-tank” concept or “full containment tank” concept, comprises an inner vessel arranged in an outer vessel. The outer vessel is typically made from reinforced concrete. The inner vessel can be made from concrete or cryogenic resistant steel. The inner surface of the concrete outer vessel is provided with a metal plating to serve as a vapour barrier and gas barrier. Furthermore it is provided up to a certain height with a cryogenic metal plating on top of an insulating layer to serve as a thermal corner protection of the concrete, indicated as secondary liner. In this first tank concept, the functions mentioned above are fulfilled by different components. The inner vessel contains the cold liquid. In the unlikely event of a leakage of the inner vessel into the outer vessel, the secondary liner prevents the cold liquid from reaching the outer concrete vessel, especially the corner area thereof. The space between the inner vessel and the outer vessel is filled with insulation material. This secondary liner makes the tank to be of a “full containment type”.

A second tank concept, indicated as “membrane tank” concept, has a thin metal plating or membrane attached to a load-bearing insulation, which again is attached to the inner surface of the outer vessel over the entire height of the outer vessel. This tank has no separate inner vessel as the membrane fulfils the functions of the inner vessel. The membrane has a complicated profile in order to allow expansion and contraction caused by the temperature changes. It is noted that this tank also has incorporated a secondary liner by means of a triplex foil within the load-bearing insulation to obtain the status of a “full containment type”.

When building such a tank according to the first tank concept, first the outer vessel is built. During the construction of the walls, a large dome-shaped carbon steel roof is built within its perimeter and, when the walls are finished, the roof is hoisted or blown to the top of the walls and fastened to close the tank. Then, metal plates are arranged at the inner side of the concrete bottom and walls and are welded to anchoring points in the concrete walls and to each other as well as to the carbon steel roof in order to provide for a vapour-tight and gas-tight enclosure. A first insulation layer is arranged on the bottom of the outer vessel, and also on part of the wall. The insulation is in the form of cellular glass, which material only reaches the desired pressure resistance with special bitumen products. Also PVC foam can be used. A ringbeam is now installed onto this insulation layer to support the inner vessel. Inside the ringbeam, additional insulation layers are applied to obtain the desired insulation value. The inner vessel is now built on top of the bottom insulation and ringbeam. The first insulation layer in the annular space and onto part of the wall is now covered by a cryogenic resistant metal plating of Invar or 9% Nickel steel to act as a liquid-tight secondary liner. These steel plates must be made to measure on location and must be welded to each other and the inner tank in a liquid-tight manner.

On top of the inner vessel, a suspended ceiling is hung from the dome-shaped roof and completely covered with a substantially thick layer of fibre-glass insulation.

Then, insulation material is arranged in the space between the wall of the inner vessel and the wall of the outer vessel. This insulation comprises a resilient glass fibre blanket against the wall of the inner tank, and the rest of the annular space is filled by pouring perlite grains.

Thus, building such a tank according to the state of the art is very labour-intensive. Herein it is the disadvantage that applying several different kinds of insulation material and sealing material at the several locations must be done at strongly different moments in time, while furthermore those activities lie on the Critical path, i.e. subsequent activities must wait until previous activities have been completed.

During use, especially the inner vessel will experience volume variations as result of thermal contraction and changing liquid load levels. This has as a consequence that the dimensions of the annular space between the inner vessel and the outer vessel vary, causing the conventionally used perlite grains to tend to settle themselves, i.e. the height of the perlite bulk decreases. In order to maintain the desired insulation value, therefore, perlite must regularly be filled. The resilient glass fibre blankets are to reduce the settling of the perlite grains, but still do not prevent the necessity of a regularly filling of perlite.

When building such a tank according to the second tank concept, i.e. a “membrane” tank, first the outer vessel is built. During the construction of the walls, a large dome shaped carbon steel roof is built within its perimeter and, when the walls are finished, the roof is hoisted or blown to the top of the walls and fastened to close the tank. Then, prefabricated insulation panels comprising of PVC or polyurethane load-bearing insulation between two plywood outer surfaces are fastened to the outer concrete vessel using load-bearing mastics to accommodate for the curvature of the tank. Thin steel membrane plates are then anchored to the plywood inner surface and welded together. In order to obtain a full containment status, the prefabricated insulation panels of the bottom and lower wall part incorporate a secondary liner within the panels of a triplex foil.

Also the membrane tank uses a suspended ceiling hung from the dome-shaped roof and completely covered with a substantially thick layer of fibre-glass insulation.

Thus, building such a tank according to the state of the art requires very accurate manufacturing processes using special ply-woods, adhesives, expensive insulation materials. The anchoring of the ply-wood panels to the concrete outer vessel, the jointing of the secondary liner of triplex foil on the job-site and the complexity of welding the complicated profiles of the steel membrane makes the entire construction of such a tank very labour-intensive and requires the use of very skilled labour.

A general disadvantage of these two types of tanks is to be seen in the need of handling and welding metal plates for manufacturing the liner and attaching the liner to the wall of the outer vessel, and welding metal plates of the inner tank or the membrane tank. WO-02/29310, the contents of which is incorporated herein by reference, has proposed a method for building a storage tank which avoids the need of metal plates. In the storage tank of this publication, which can be indicated as a third type of tank, PVC-foam plates provided with a coating provided with gravel are attached to the inner side of the concrete wall of the tank. Over the PVC-foam, a monolithic coating layer is applied. On the bottom of the tank, a first coating layer is applied; then PVC-foam blocks are arranged, and finally a monolithic coating layer is applied. The coating layers are sprayed.

The third type of tank, and its building method, as proposed by WO-02/29310 already has major advantages over the first and second types of tank. Nevertheless, further improvements are possible.

An important aim of the present invention is to provide a still further improved tank concept.

More particularly, the present invention aims to provide a design and building method for a storage tank for cold liquids, wherein a substantial saving on building time and building cost can be achieved, while maintaining or perhaps even improving the insulation properties and the sealing properties.

### SUMMARY OF THE INVENTION

According to an important aspect of the present invention, the wall and floor of a cold storage tank are provided, at the inside, with a multilayer sprayed insulation comprising at least a layer of poly-urethane foam sandwiched between two sprayed layers of poly-urethane coating.

The layer of poly-urethane foam may entirely or partly be made from blocks, but preferably the layer of poly-urethane foam is also sprayed, in which case the entire insulation structure is applied by spraying, which achieves an enormous saving of building time and labour.

Further, all layers of the insulation structure are made from substantially the same material, so the insulation structure as a whole behaves as a monolithic layer.

### BRIEF DESCRIPTION OF THE DRAWINGS

These and other aspects, features and advantages of the present invention will be further explained by the following description with reference to the drawings, in which same reference numerals indicate same or similar parts, and in which:

FIGS. 1-6 are cross sections schematically illustrating subsequent steps in a method for building a cold storage tank in accordance with the present invention;

FIG. 7 schematically illustrates an anchor point.

### DETAILED DESCRIPTION OF THE INVENTION

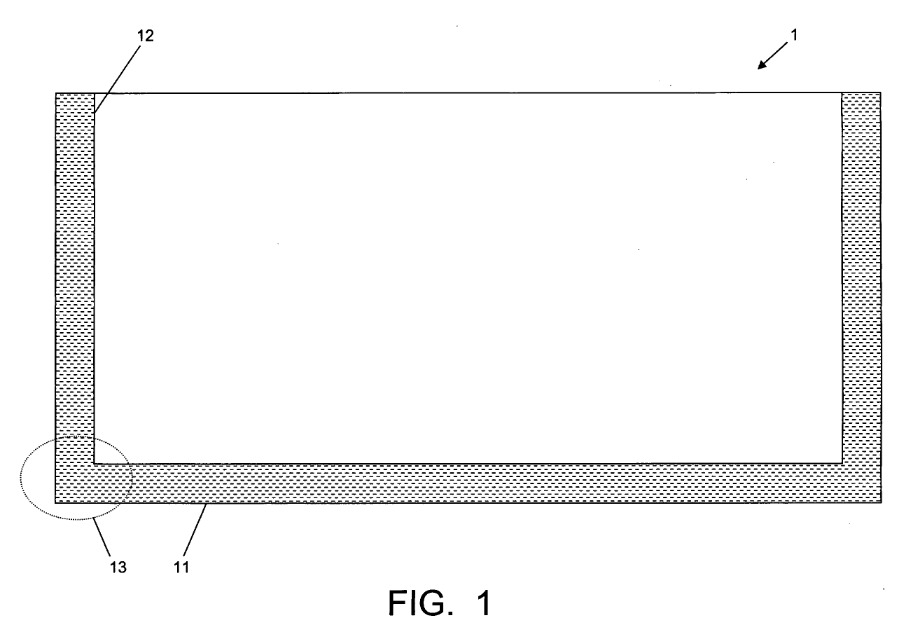

FIG. 1 schematically illustrates a first step in a building process for building a cold storage tank 1. In this first step, a concrete floor 11 and concrete walls 12 are built, in a conventional manner. The walls 12 and floor 11 meet in corner areas 13.

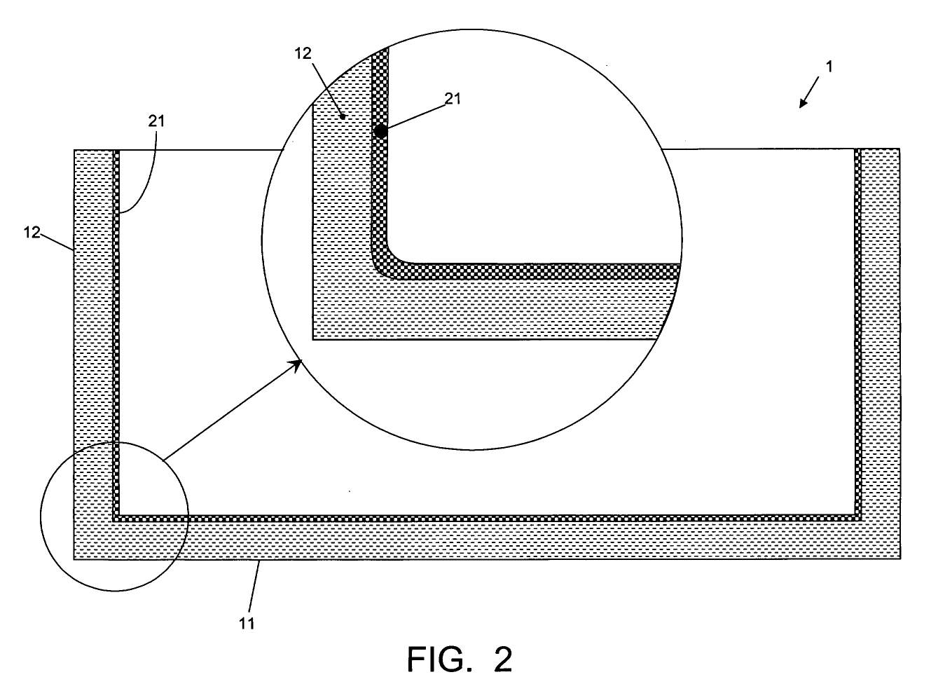

As a next step, illustrated in FIG. 2, a first coating 21 is applied at the inner surfaces of the floor 11 and the walls 12, preferably, as shown, over the entire height of the walls 12. The first coating 21 is a poly-urethane material (PU), applied by spraying, to a suitable thickness of about 3 mm. The first coating 21 will function as a vapour barrier and gas barrier, and is adapted to be vapour-tight and gas-tight. It is also liquid-tight.

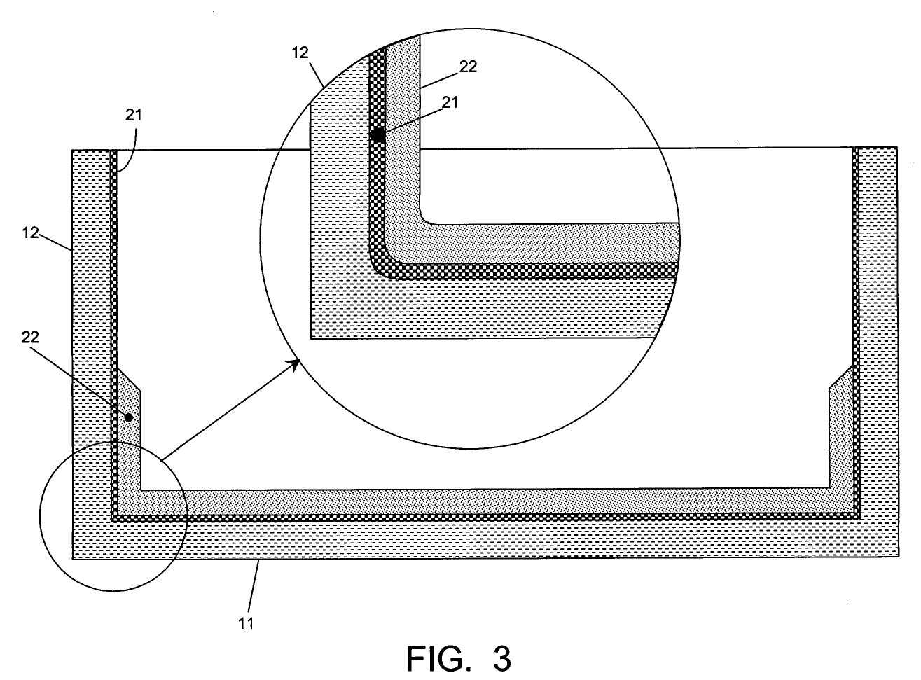

As a next step, illustrated in FIG. 3, a first PU foam layer 22 is applied on the inner surface of the coating 21. The first PU foam layer 22 may be applied over the full height of the walls 12 but, preferably, as shown, the first PU foam layer 22 is applied on the floor part of the coating 21 and up to a certain height on the wall part of the coating 21.

Although parts of the first PU foam layer 22 may be applied as individual blocks, the first PU foam layer 22 is preferably applied by spraying, to a suitable thickness in the order of about 150 mm or more. In view of this thickness, the first PU foam layer 22 may actually be applied as a succession of multiple layers. The first PU foam layer 22 will function as an insulation.

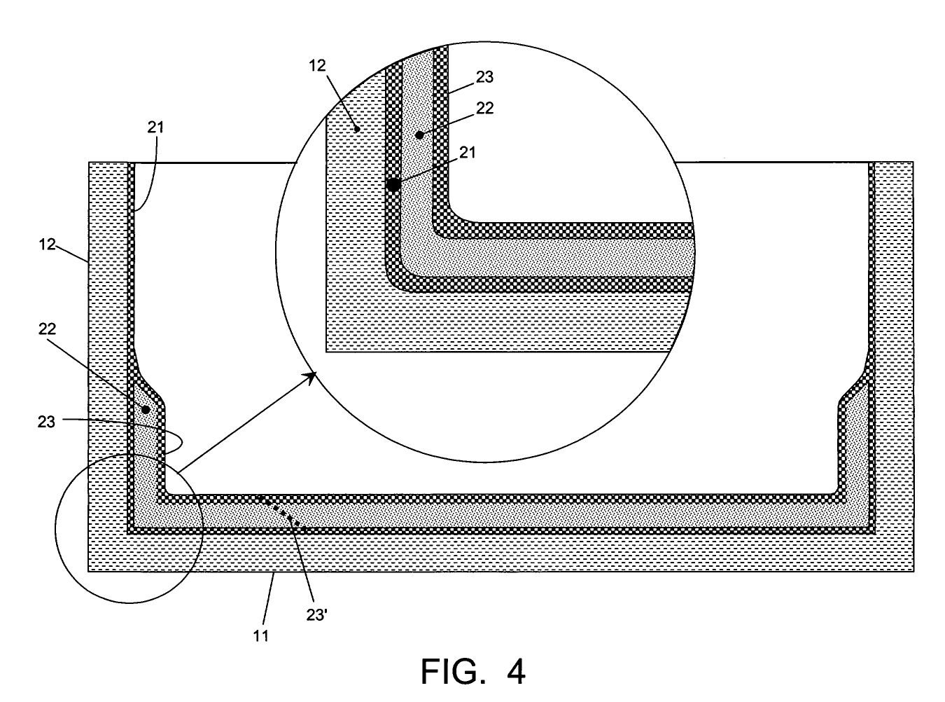

As a next step, illustrated in FIG. 4, a second PU coating 23 is applied on the inner surface of the first PU foam layer 22. The second PU coating 23 is applied by spraying to a suitable thickness of about 3 mm. The second PU coating 23 will function as a liquid barrier, and is adapted to be liquid-tight. Although the second PU coating 23 may be applied over the entire height of the walls 12, this is not always necessary. In case the first PU foam layer 22 extends over only part of the height of the wall 12, as illustrated, the second PU coating 23 should extend higher than the first PU foam layer 22 and should merge with the first PU coating 21. Thus, the first PU foam layer 22 is completely encapsulated by PU coating 21, 23, in order to assure that the first PU foam layer 22 remains dry.

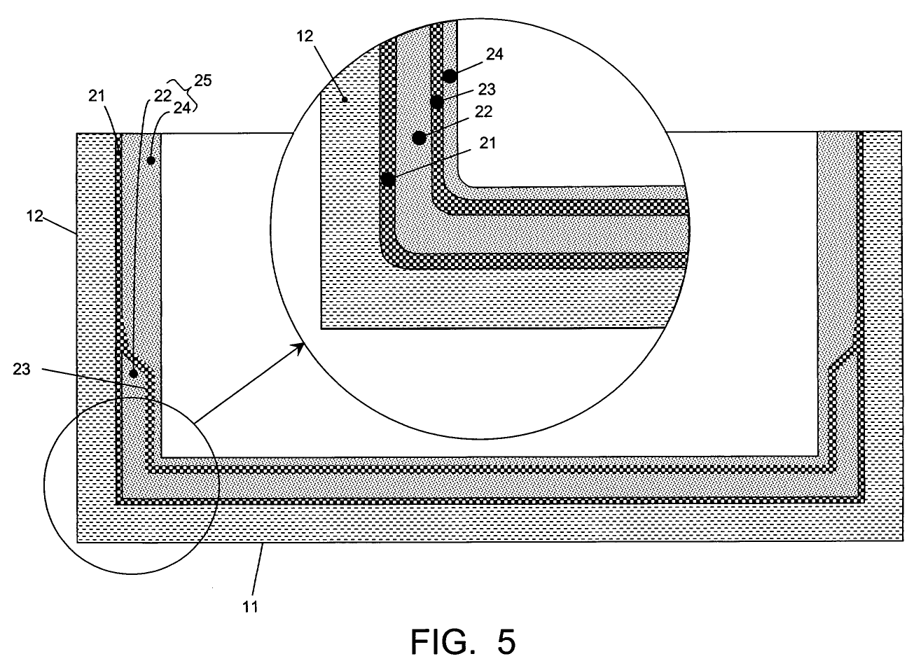

As a next step, illustrated in FIG. 5, a second PU foam layer 24 is applied on the inner surface of the first PU foam layer 22 and the second PU coating 23, preferably, as shown, over the entire height of the walls 12. Although parts of the second PU foam layer 24 may be applied as individual blocks, the second PU foam layer 24 is preferably applied by spraying. The second PU foam layer 24 will function as an insulation, together with the first PU foam layer 22. The combined thickness of the first PU foam layer 22 and the second PU foam layer 24 is suitably in the order of 300 mm or more. Thus, in locations where the first PU foam layer 22 is present, the thickness of the second PU foam layer 24 is reduced, whereas in locations above the first PU foam layer 22, the thickness of the second PU foam layer 24 preferably is in the order of 300 mm or more. In view of this thickness, the second PU foam layer 24 may actually be applied as a succession of multiple layers.

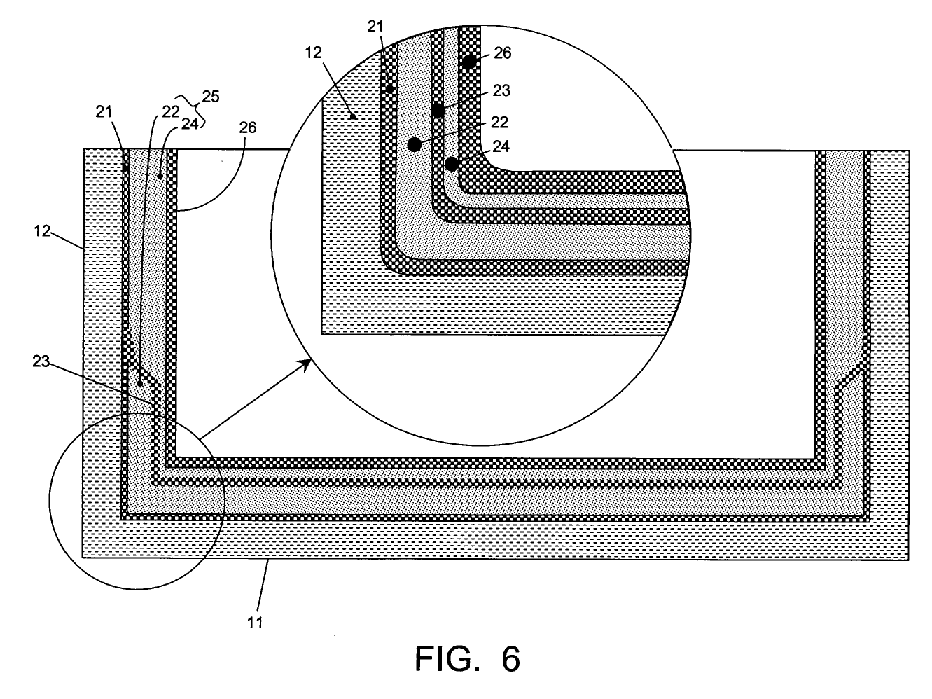

As a next step, illustrated in FIG. 6, a third PU coating 26 is applied on the inner surface of the second PU foam layer 24, preferably, as-shown, over the entire height of the second PU foam layer 24. The third PU coating 26 is applied by spraying to a suitable thickness; a thickness of about 4-5 mm is adequate, although a thickness of about 3 mm is usually sufficient. The third PU coating 26 will function as a membrane, and is adapted to be liquid-tight.

Placing a roof on top of the tank can be done by conventional building methods, so this needs not be explained in further detail. It is noted, however, that the roof, once built, can be sprayed with foam and/or coating PU as well.

It is possible to place an inner vessel inside the tank 1 thus built, if desired, in which case the cold liquid would be contained in the inner vessel only. However, the tank-in-tank concept has disadvantages, as mentioned above, while further the tank-in-tank concept does not fully utilize the storage capacity of the tank. An important advantage of the tank 1 is that the tank 1 itself is suitable to act as cold liquid container, without a separate inner vessel being necessary. Then, in operation, the cold liquid (not shown for sake of simplicity) would be in contact with the third PU coating 26. The first PU foam layer 22 and the second PU foam layer 24 together act as thermal insulation between the cold liquid contents and the concrete floor 11 and walls 12, the first PU coating 21 and the third PU coating 26 (the thickness of which is exaggerated in the figures) also contributing insulative capacity. The third PU coating 26 acts as membrane, protecting the foam 24 against entry by the cold liquid. The first PU coating 21 acts as barrier, protecting the foam 22, 24 against entry by moist or vapour which penetrates from the surroundings through the concrete floor 11 and walls 12.

Under normal circumstances, the second PU coating 23 does not need to come into action. Only in case of a leakage of the third PU coating 26 (and leakage of a possible inner vessel), cold liquid will enter the foam 24, and will ultimately reach the second PU coating 23. If the second PU coating 23 would be absent, the cold liquid would be separated from the concrete floor 11 and walls 12 by the first PU coating 21 only. In principle, this separation is sufficient in that no cold liquid will leak through to the concrete; in any case, the first PU coating 21 is liquid-tight. However, the thermal insulative capacity of the first PU coating 21 alone is insufficient for protecting the concrete so that, in such circumstances, the concrete would cool down to a very low temperature; as a consequence, the risks of concrete cracks increase. These risks are largest in the corner areas 13 of the tank 1, i.e. where the walls 12 and floor 11 meet. The second PU coating 23, physically separate from the third PU coating 26, now acts as an additional protection for these corners, keeping the cold liquid away from these corners, maintaining at least the first PU foam layer 22 operational as protective insulation between the concrete and the cold liquid.

It is noted that it is best to protect the entire floor 11 and at least a part of the walls 12 (depending on the height of cold liquid to be expected in a worst-case scenario) against the very low temperatures, so it is preferred that the second PU coating 23 extends over the entire floor 11, as illustrated. However, since the potential problems caused by cold liquid are largest in the corner areas 13, it may, depending on design, be sufficient if the second PU coating 23 (and the first PU foam layer 22) is arranged in the corner area only: in that case, the second PU coating 23 would extend beyond the first PU foam layer 22 and merge with the floor part of the first PU coating 21, as indicated by a dotted line 23′ in FIG. 4, to keep the first PU foam layer 22 encapsulated.

So, the second PU coating 23 acts as a backup for the third PU coating 26, having the same mechanical properties as the third PU coating 26. The second PU coating 23 should be separate from the third PU coating 26 in order to prevent possible failures in the third PU coating 26 from damaging the second PU coating 23. The second PU coating 23 maintains sufficient insulation (i.e. first PU foam layer 22 remaining dry instead of being drenched with cold liquid) between cold liquid and concrete. It is possible to protect the entire height of the walls 12 in this way, by having the first PU foam layer 22 and the second PU coating 23 extend over the full height of the walls 12.

For actually maintaining sufficient insulation, it is preferred that the first PU foam layer 22 is as thick as possible. In a suitable embodiment, the thickness of the first PU foam layer 22 is chosen in the range 150-250 mm, while the thickness of the second PU foam layer 24 is chosen in the range 150-50 mm, the combined thickness being approximately 300 mm.

The main advantages of the present invention are associated with the building process. Once the concrete floor has been laid and the concrete walls have been erected, the entire thermal protection system can be applied by spraying, using in principle the same material (PU) for all layers. Since only one appplication technique is used, the work can be done by only one construction company (sub-contractor), which is much more efficient than having to coordinate different teams of worksmen performing different works on necessarily pre-defined times.

Especially, it is an advantage that the thermal protection system does not need to contain any metal parts any more.

It is also an advantage that all thermal protection layers are made from the same material or material family (poly urethane), so that all layers have identical or at least comparable thermo-mechanical properties such as expansion/ contraction coefficient.

A material which can very advantageously be used as gas-tight and liquid-tight coating in the present invention is a two-component poly urethane composition which is commercially available from the company TAGOS S. r. L. in Busto Arsizio, Italy, under the brand name IWR ESATEC HR 1000. In the market, this material is also known under the name IWR CRYOCOAT HR, and is commercially available under this name from the company INSU-W-RAPID B.V. in Tilburg, the Netherlands. The coating material is sprayed by means of a mix/spray head, and the components immediately undergo a chemical reaction which is finished after approximately 2 minutes, after which a further layer can be applied. In each spraying cycle, the thickness of the layer to be applied can be set as desired. A suitable value for the thickness of the layers to be applied is in the range of 2-4 mm, but it is possible to apply thinner or thicker layers. It is noted that, in the figures, the thicknesses of the different layers are not shown to scale.

It is possible to build the thermal protection system over the entire tank as a whole, i.e. to apply one layer over the entire inner surface of the tank, to apply a second layer over the entire inner surface of the tank, etc. In a preferred embodiment of the present invention, it is possible to apply the entire thermal protection system in one section of the tank wall, and then apply the entire thermal protection system in an adjacent section, etc. Suitably, such section may extend over the entire height of the wall and have a width in the order of a few meters. Thus, it is possible to confine the work to one part of the tank while other work may be done in another part of the tank, without the workers being in each others way.

As regards the insulating foam, to be used for the foam layers 22 and 24, it is noted that poly-urethane foams are suitable if such foam has a sufficiently high coefficient of thermal stress resistance, indicated as CTSR-value. The CTSR is defined according to the following formula:

$$CTSR = \frac{σ \cdot ( 1 - γ )}{E \cdot α \cdot ( {T}_{2} - {T}_{1} )}$$

where:
σ indicates the tensile strength of the foam at −165° C. (kPa; minimum value of all three directions);
E indicates the tensile modulus of the foam at −165° C. (kPa; minimum value of all three directions);
α indicates the average linear constriction coefficient of the foam from −165° C. up to +21° C. (maximum value of all directions);
γ=0.4, estimated value for Poisson's ratio at −165° C. (other values may be used if substantiated by experimental data)
T₂−T_{1 =}185° C., estimated value for temperature difference between cold surface and surroundings
   Thus, apart from mechanical design criteria, the density and chemical formulation of the foam should preferably be selected in such a way that the CTSR-value is sufficiently high, preferably in the order of approximately 3 or higher.

It is noted that foam compositions meeting this requirement are commercially available, so it is not necessary here to give more details on the composition.

Normally, the fixation of the thermal protection system to the floor and the walls of the tank is sufficiently strong to withstand forces that occur due to temperature variations. However, this fixation is based on adhesion between PU coating 21 and concrete, and it may be preferred to provide the walls 12 of the tank, and perhaps also the floor 11, with anchor points which offer a mechanical fixation of the PU to the concrete. Such anchor point should combine mechanical strength with little or no thermal conduction.

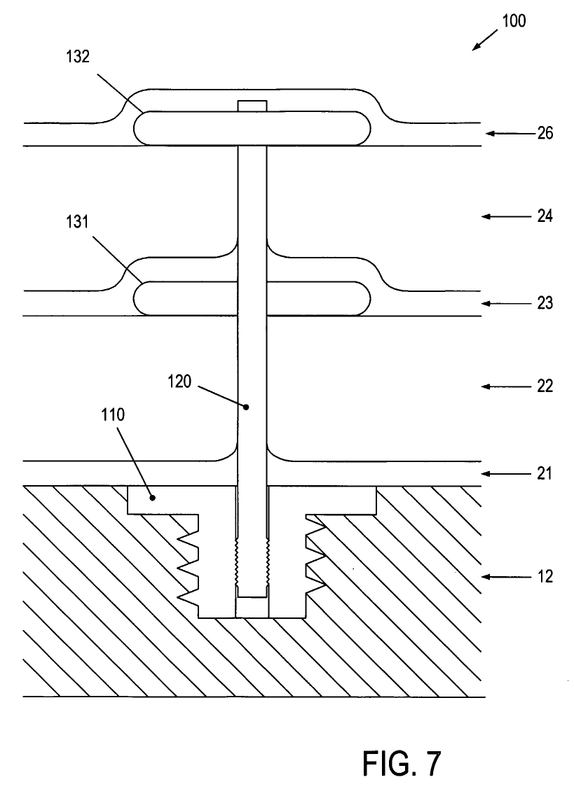

FIG. 7 is a cross section illustrating an embodiment of a suitable anchor point 100 in accordance with the present invention. The anchor point 100 comprises a bush 110, fixed in the concrete of the wall 12, either by being embedded in the concrete when the concrete was being poured into a formwork or by being screwed into the concrete after the concrete has hardened. A suitable material for the bush 110 is glass fiber reinforced polyester, epoxy or phenolic resin which are materials known per se.

The bush 110 is provided with a threaded bore, into which a screw rod 120 is screwed, so that the screw rod 120 extends substantially perpendicularly with respect to the inner surface of the wall 12. The screw rod 120 may be made from the same material as the bush 110.

After the first PU coating 21 and the first PU foam layer 22 have been applied to the wall 12, a first retaining plate 131 is screwed onto the screw rod 120, which first retaining plate 131 may be made from the same material as the screw rod 120. The first retaining plate 131 is screwed tight against the first PU foam layer 22, thus providing a mechanical fixation of the combination of the first PU coating 21 and the first PU foam layer 22. Then, the second PU coating 23 is applied on the first PU foam layer 22, over the first retaining plate 131.

Then, after the second PU foam layer 24 has been applied, a second retaining plate 132 is screwed onto the screw rod 120, which second retaining plate 132 may be made from the same material as the first retaining plate 131. The second retaining plate 132 is screwed tight against the second PU foam layer 24, thus providing a mechanical fixation of the second PU foam layer 24, while also adding to the fixation of the underlying layers. Then, the third PU coating 26 is applied on the second PU foam layer 24, over the second retaining plate 132.

If desired, if it is considered that the second retaining plate 132 suffices, the first retaining plate 131 may be omitted.

If desired, the retaining plate(s) may be screwed so tight that the underlying foam layers 22 and 24 are compressed.

It should be clear to a person skilled in the art that the present invention is not limited to the exemplary embodiments discussed above, but that several variations and modifications are possible within the protective scope of the invention as defined in the appending claims.

For instance, the vessel of the tank 1, i.e. floor 11 and walls 12, are not necessarily made from concrete; in an alternative embodiment, they may be made from a suitable metal. Since metal is vapour-tight and gas-tight, the first PU coating 21 may be omitted in such embodiment, but the first PU coating 21 may also be maintained.

1. Storage tank suitable for storing cold liquids, comprising a floor and walls meeting each other in a corner area, the storage tank further comprising a non-metallic thermal protection system on the inner surface of its floor and walls, this protection system comprising, at least in the corner areas, an array of layers arranged on top of each other, namely, seen from the walls towards the inside of the tank:
a first foam layer having good thermal insulation properties;
a liquid-tight coating applied on the inner surface of the first foam layer;
a second foam layer having good thermal insulation properties, arranged on the inner side of the coating;
a liquid-tight coating arranged on the inner side of the second foam layer;
the first foam layer being fully embedded between liquid-tight layers.

2. Storage tank according to claim 1, wherein the floor and walls are made from a vapour-tight and gas-tight material, for instance metal.

3. Storage tank according to claim 1, wherein the floor and walls are made from concrete, preferably reinforced concrete, and wherein said array of layers further comprises a vapour-tight and gas-tight coating between floor and walls on the one hand and the first foam layer on the other hand.

4. Storage tank according to claim 1, wherein said coating layers are applied by spraying.

5. Storage tank according to claim 1, provided with a non-metallic thermal protection system on the inner surface of its floor and walls, wherein the thermal protection system comprises:
[a] a first coating applied by spraying on the inner surface of the floor and walls of the tank, the first coating being adapted to be vapour-tight and gas-tight;
[b] a first foam layer arranged on the inner side of the first coating, the first foam layer being adapted to have good thermal insulation properties;
[c] a second coating applied by spraying on the inner surface of the first foam layer, the second coating being adapted to be liquid-tight so as to be able to act as a liquid-barrier;
[d] a second foam layer arranged on the inner side of the first foam layer and on the inner side of the second coating, the second foam layer being adapted to have good thermal insulation properties;
[e] a third coating arranged by spraying on the inner side of the second foam layer, the third coating being adapted to be liquid-tight so as to be able to act as a membrane.

6. Storage tank according to claim 1, provided with a non-metallic thermal protection system on the inner surface of its floor and walls wherein the floor and walls are made from a vapour-tight and gas-tight material, for instance metal, wherein the thermal protection system comprises:
[b] a first foam layer arranged on the inner surface of the floor and walls of the tank, the first foam layer being adapted to have good thermal insulation properties;
[c] a second coating applied by spraying on the inner surface of the first foam layer, the second coating being adapted to be liquid-tight so as to be able to act as a liquid-barrier;
[d] a second foam layer arranged on the inner side of the first foam layer and on the inner side of the second coating, the second foam layer being adapted to have good thermal insulation properties;
[e] a third coating arranged by spraying on the inner side of the second foam layer, the third coating being adapted to be liquid-tight so as to be able to act as a membrane.

7. Storage tank according to claim 6, further comprising:
[a] a first coating applied by spraying on the inner surface of the floor and walls of the tank, between floor and walls on the one hand and the first foam layer on the other hand, the first coating being adapted to be vapour-tight and gas-tight.

8. Storage tank according to claim 1, wherein the first coating, the first foam layer, the second coating, the second foam layer, and the third coating are made from the same material or material family.

9. Storage tank according to claim 8, wherein the first coating, the second coating, and the third coating have mutually the same composition.

10. Storage tank according to claim 1, wherein the first coating, the first foam layer, the second coating, the second foam layer, and the third coating are made from poly urethane.

11. Storage tank according to claim 1, wherein, at least in a part of the thermal protection system, the first foam layer is applied in the form of foam blocks.

12. Storage tank according to claim 1, wherein, at least in a part of the thermal protection system, the second PU foam layer is applied in the form of foam blocks.

13. Storage tank according to claim 1, wherein, at least in a part of the thermal protection system, both foam layers are applied by spraying.

14. Storage tank according to claim 1, wherein the first coating has a thickness in the range of 1-10 mm, preferably in the order of about 3 mm.

15. Storage tank according to claim 1, wherein the first coating extends over the entire surface of the floor and over the entire height of the walls.

16. Storage tank according to claim 1, wherein, in the corner area, the first and second foam layers have an overall thickness in the range of 100-500 mm, preferably in the order of about 300 mm.

17. Storage tank according to claim 1, wherein, in the corner area, the thickness of the first foam layer is substantially equal to the thickness of the second foam layer.

18. Storage tank according to claim 1, wherein, in the corner area, the thickness of the first foam layer is larger than the thickness of the second foam layer.

19. Storage tank according to claim 1, wherein the first and second foam layers extend over the entire surface of the floor.

20. Storage tank according to claim 19, wherein the second coating extends over the entire surface of the floor.

21. Storage tank according to claim 1, wherein the first and second foam layers extend over the entire height of the walls.

22. Storage tank according to claim 21, wherein the second coating extends over the entire height of the walls.

23. Storage tank according to claim 1, wherein the first foam layer extends over only part of the height of the walls and/or over only part of the surface of the floor.

24. Storage tank according to claim 23, wherein the second coating extends beyond the first foam layer.

25. Storage tank according to claim 24, wherein said array of layers further comprises a vapour-tight and gas-tight first coating between floor and walls on the one hand and the first foam layer on the other hand, and wherein the second coating merges with the first coating.

26. Storage tank according to claim 1, wherein the second coating has a thickness in the range of 1-10 mm, preferably in the order of about 3 mm.

27. Storage tank according to claim 1, wherein the third coating has a thickness in the range of 3-10 mm, preferably in the order of about 4-5 mm.

28. Storage tank according to claim 1, wherein the third coating extends over the entire surface of the floor and over the entire height of the walls.

29. Storage tank according to claim 1, further provided with insulating anchor points for providing a mechanical fixation of the thermal protection system to the floor and walls of the tank.

30. Storage tank according to claim 29, wherein each anchor point comprises:
a bush fixed in a wall or a floor, the bush being provided with a threaded bore;
a screw rod screwed into the bush; and
at least one retaining plate screwed tight on the screw rod, pressing at least some of the layers of the thermal protection system against the corresponding wall or floor.

31. Storage tank according to claim 30, wherein an anchor point comprises at least two retaining plates screwed tight on the same screw rod, a first retaining plate being embedded within the thermal protection system, preferably between a foam layer and a coating layer.

32. Storage tank according to claim 30, wherein the bush is made from glass fiber reinforced polyester;
wherein the screw rod is made from a phenolic resin reinforced with glass fibers; and
wherein the at least one retaining plate is made from a phenolic resin reinforced with glass fibers.

33. Storage tank according to claim 1, wherein each foam layer has a sufficiently high CTSR value, preferably in the order of about 3 or higher.

34. Method for applying a thermal protection system in a cold liquid storage tank having a floor and walls, the thermal protection system comprising:
a liquid barrier membrane for holding the liquid;
a thermal insulation layer arranged between the membrane and the floor and walls of the tank;
a secondary liquid barrier embedded within the thermal insulation layer;
preferably, a vapour-tight and gas-tight liner attached to the inner surface of the floor and walls of the tank;
wherein at least at one location of the tank, all layers of the thermal protection system are applied by a spraying process, preferably by spraying a substance on the basis of poly urethane.
